(19) United States
(12) Patent Application Publication
(10) Pub. No.: US 2011/0154495 A1
(43) Pub. Date: Jun. 23, 2011

(54) MALWARE IDENTIFICATION AND SCANNING

(76) Inventor: Odd Wandenor STRANNE, Odsmal (SE)

(21) Appl. No.: 12/643,032

(22) Filed: Dec. 21, 2009

(51) Int. Cl. G06F 21/22; G06N 3/12

(52) U.S. Cl. 726/24; 706/13

(57) ABSTRACT

A method for automatically generating a genetic signature for a set of malware, comprising parsing (step S11) the malware to identify a set of binary comparable features present in said malware, storing (step S5; step S11) all binary comparable features occurring in said set of malware, determining (step S13, S14) a subset comprising binary comparable features occurring in at least a predetermined portion of all malware in the set, and including (step S15) representations of the binary comparable features in the subset in the genetic signature.

Compared to prior art systems, the genetic signature according to the present invention is unique in that it does not rely on relationships between individual features, only on their occurrence in various malware in the set. A genetic signature according to the present invention may for example consist of associations to five different features which have no relation to each other at all.

### FIELD OF THE INVENTION

The present invention relates to the process of identifying malware. More specifically, the invention relates to a method for determining a genetic signature for a class of malware. This signature can then be used in a scanning procedure to identify a computer program as malware.

### BACKGROUND OF THE INVENTION

For as long as data has been shared between computers, computer viruses have existed. When a virus infected program file is executed, the virus is activated and may cause unwanted effects, sometimes harmful to the computer system. Computer viruses are typically short sections of low level program code incorporated in an otherwise legitimate program file. Due to their sophistication, traditional computer viruses require a relatively high level of skill to write. Also, they typically consist of machine code, and are thus difficult to disguise, and any virus using an existing kernel of code will be identifiable by the byte-pattern of that code.

With the rapid growth of Internet, accessible bandwidth, and the associated sharing of enormous amounts of data between computers, it has become increasingly more difficult to control which files enter a system. At the same time as legitimate files are downloaded, also other, malicious software files may be downloaded unless the user is extremely cautious.

Such malicious software, or malware, has become increasingly common, and includes for example spyware, trojans, and worms. Once activated, malware may write to system registry files (e.g. Windows Registry), influence on-going program processes, and disturb the performance of the system. As a few examples, a spyware may collect and communicate information about the system and its user to an outside party; a trojan may deactivate protective software to allow additional, even more malicious software to enter the system.

Malware is different from a virus in that it is a stand-alone program file, e.g. a script or executable file. As a consequence, malware programs are generally easier to create, and the variation may be greater. Further, they may be written in high level program languages, and traditional virus detection, e.g. based on byte-pattern detection, is often less effective.

Identification of a copy of a particular file may be accomplished by simple hash detection, i.e. a hash is computed for the malicious program, and then compared to hashes calculated for files to be searched. However, servers that distribute malware are often adapted to make minor changes to the code of the program on a byte level, i.e. changes that are irrelevant to the function of the program, but lead to a different hash. Even if the detection rate may be improved by implementing partial hashes, i.e. by eliminating portions of a file that are known to be adaptable, hash detection is still unsuccessful when dealing with a fast flow of malware with varying appearance. Another problem with using one hash to identify each separate malware is that the number of different hashes becomes very large. This in turn means that a definition file, containing all hashes, which is used to update a protection software, becomes difficult to handle.

Under these circumstances, there is a need for a method which is able to recognize a malware based on its fundamental components. The presence of particular components, sometimes referred to as “genes”, may be used as an indicator that a file belongs to a certain class, or has a certain function.

Document US 2008/0005796 discloses one approach to such gene-based software classification used for malware detection. In this particular case, the genes represent various functionalities identified in functional blocks extracted from the binary code. Each gene describes or identifies a different behavior or characteristic of the file.

However, the genes in US 2008/0005796 are defined based on a manual analysis of relevant functions and their relative order. Significant experience is therefore required in order to provide the basis for the gene definition and software classification. Further, as the approach in US 2008/0005796 is based on behavioral aspects of the malware, it will typically only be able to provide a general classification of a program, and not provide a more specific identification. As a result, it is difficult to activate adequate counter measures, at least without a further analysis.

### SUMMARY OF THE INVENTION

It is an object of the present invention to improve prior art solutions for malware detection, and to provide malware detection which allows a more specific identification of a malware.

According to a first aspect of the present invention, this and other objects are achieved by a method for determining a genetic signature for a class of malware, comprising for each malware in the set, parsing the malware to identify a set of binary comparable features present in the malware, which features are comparable on a binary level, storing all binary comparable features occurring in the set of malware, determining a subset of binary comparable features, the subset comprising binary comparable features occurring in at least a predetermined portion of all malware in the set, and including representations of the binary comparable features in the subset in the genetic signature.

Compared to prior art systems, the genetic signature according to the present invention is unique in that it does not rely on relationships between individual features, only on their occurrence in various malware in the set. A genetic signature according to the present invention may for example consist of associations to five different features which have no relation to each other at all.

Expressed differently, the strength of the prior art system mentioned above lies in the combination of several features (e.g. API calls and strings) in a specific order, to form a “gene” which has an ability to identify similar software (high “eigenvalue”). According to the present invention, as the features themselves are selected based on their occurrence in the set of malware, it is the combination of individual features, irrespective of relative order, that has an ability to identify similar software (high “eigenvalue”).

This makes the genetic signature according to the present invention potentially more effective when seeking to identify a relation between a data collection and the set. The present invention is unaffected by attempts to “disguise” the malware, e.g. by rearranging individual features.

A genetic signature generated according to the present invention will enable identification of, and therefore protection against, all malware with close relation to a specific set of malware. This is advantageous, as it enables launching of any counter measure known to be useful against this type of malware. As an example, specific “cleaning” procedures, designed to return the computer system to its original state, may be activated.

Further, the present invention enables proactive malware detection, as the genetic signature often will remain unchanged when the malware is modified.

Another advantage with the genetic signatures according to the present invention is that they are easier to generate automatically. In the prior art, where genes correspond to complex combination of features, the process of identifying genes becomes difficult to automate.

The binary comparable features may comprise text strings. In this case, the extracted data may be normalized before identifying binary comparable features. Such normalization may include, for example, removing distinctions between upper and lower case, different string codes and type of ASCII.

Alternatively, or in combination, the binary comparable features may relate to functional content, such as embedded functions.

The predetermined portion may be for example 80%, 90%, or 100%. The greater the predetermined portion, the greater is the “eigenvalue”, or ability to identify the specific type of malware, of the particular features. If the predetermined portion is 100%, this means that the features in the subset occur in every malware in the set.

According to one embodiment, the subset comprises binary comparable features occurring in at least a first predetermined portion of malware in the set, and no more than a second predetermined portion of malware in other sets. In this case, the first predetermined portion may be relatively high, e.g. more than 80%, and the second predetermined portion may be relatively low, e.g. less than 20%. In an ultimate case, a binary comparable feature occurs in 100% of the malware in the current set, and in 0% of the malware in other sets.

According to one embodiment, binary comparable features with high occurrence in all software are removed from the subset. Such features generally contribute less to the efficiency of the genetic signature, as they are found in most software. The removal of such features may be done by accessing a look-up table listing such features.

According to a second aspect of the present invention, the above mentioned object is achieved by a method for determining whether a data collection belongs to a specific set of malware, comprising storing a set of representations of binary comparable features associated with a set of genetic signatures, creating a look-up table where each entry is associated with one of the representations, parsing the data collection to identify a set of binary comparable features present in the data collection, marking entries in the look-up table associated with identified binary comparable features, and determining that the data collection belongs to a specific set of malware if every entry associated with a binary comparable feature of a genetic signature representing the specific malware set is marked.

The representations preferably have a predetermined length, so that the memory required to store one representation is constant. This facilitates the storing and processing of the representations, both on server and client side.

For example, the representation may be a hash of the feature, which is easy to handle in the look-up process.

The look-up table may be partitioned in several tables, in order to facilitate the look-up procedure. For example, the table can comprise a set of 256 tables, wherein each table stores hashes having a specific first byte. Further, for each of the 256 tables there may be 256 sub-tables, wherein each sub-table stores hashes having a specific second byte. In this way, the two first characters of the hash may be used to identify one out of 65536 tables, significantly reducing the number of operations required to establish if the hash exists in the table or not.

It is noted that the invention relates to all possible combinations of features recited in the claims.

### BRIEF DESCRIPTION OF THE DRAWINGS

This and other aspects of the present invention will now be described in more detail, with reference to the appended drawings showing a currently preferred embodiment of the invention.

FIG. 1 is a schematic block diagram of a system according to an embodiment of the present invention.

FIG. 2 is a schematic block diagram of the server part of the system in FIG. 1.

FIG. 3 is a schematic block diagram of the client part of the system in FIG. 1.

FIGS. 4-7 are flow charts of procedures forming part of an embodiment of the present invention.

### DETAILED DESCRIPTION

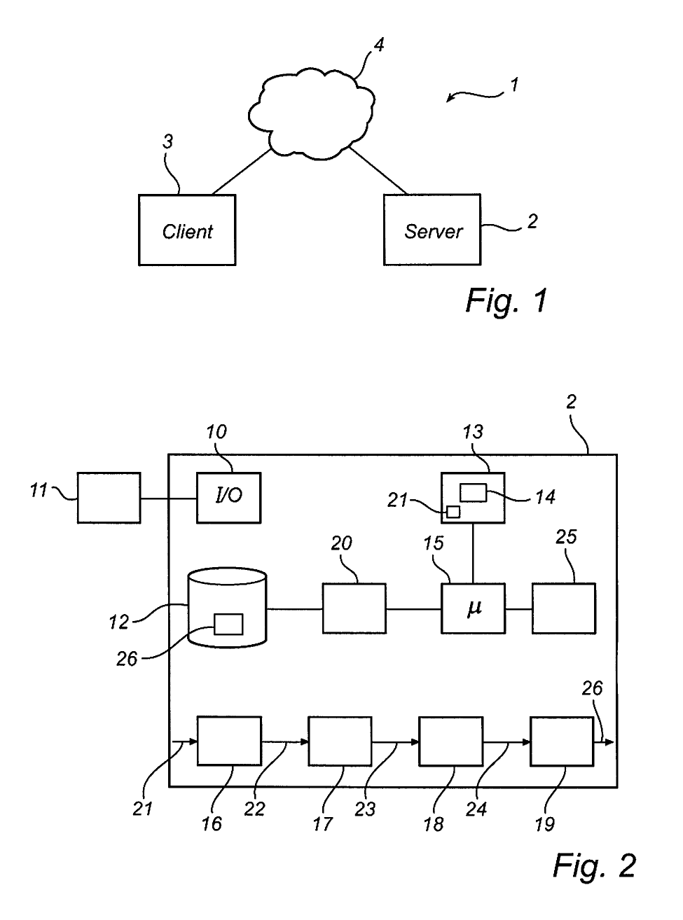

FIG. 1 shows a malware detection system 1 according to an embodiment of the present invention. The system has two main parts; a server part 2 where genetic signatures are determined based on known malware, and a client part 3, where scanning of collections of data, e.g. computer files or data streams, is performed, in order to identify known and previously unknown malware based on the genetic signatures. The systems are able to communicate at least temporarily via a computer network connection 4 such as the Internet. The network connection allows the server part 2 to send additional genetic signatures to the client part 3. Such updates may be performed regularly, according to an automatic subscriber procedure known in the art, or occasionally, following a user instruction. The network connection 4 also allows the client part 3 to communicate with the server part 2, for example in order to return scanning results and statistics, as well as newly identified previously unknown malware, to the server part 2. Such new malware can be classified in the server, and used for future genetic signature determination. The two systems and their functions will be described in greater detail below.

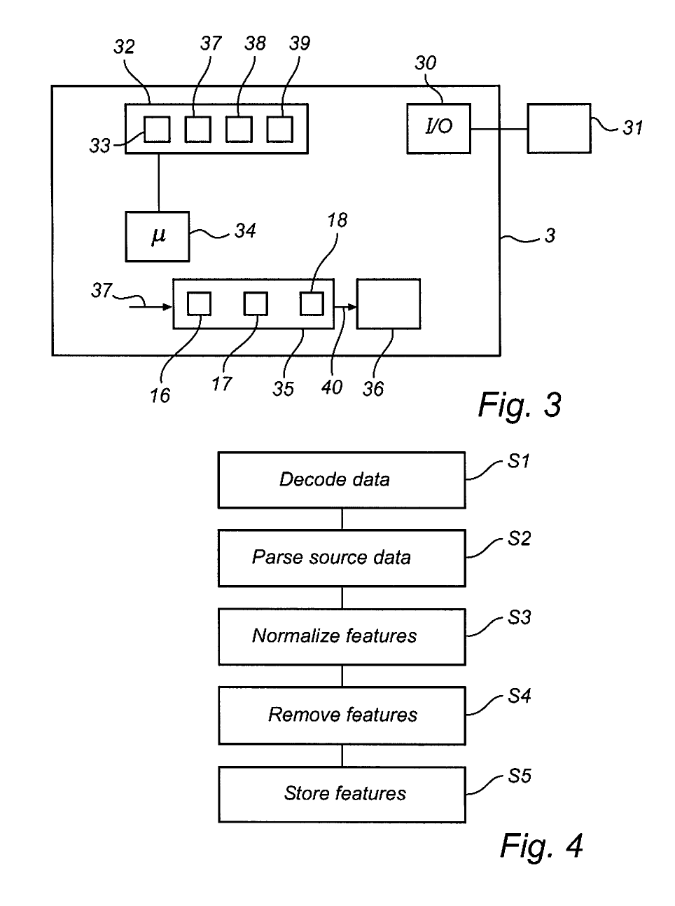

With reference to FIG. 2, the server part 2 comprises an I/O-unit 10, connected to the network connection 4 as well as to any suitable user interface 11, such as keyboard, mouse, etc. The server part 2 further includes a database 12, and a database management system (DBMS) 20, preferably a relational database management system (RDBMS), such as MySQL®. The server part 2 further comprises a memory 13 storing software code 14, and a processor 15, arranged to execute the software 14. When executed, the software creates several processes running on the server 2, including a decoder 16, a parser 17, a normalizer 18, a remover 19 and a signature definition module 25. The server part 2 may also include suitable hardware, specifically adapted to form part of these processes.

The decoder 16 is arranged to receive raw data 21, typically a data file received by the I/O-unit 10 and stored in memory 13, and to decode this data into data 22 in an acceptable source data format. Most importantly, the decoder 16 is adapted to restore scrambled code and data. For example, the decoder may apply various decoding and decompression algorithms, and “unpack” a software.

The parser 17 is arranged to receive the decoded output, source data, 22 from the decoder 16, and act as a filter to extract relevant data in the form of identifiable features. The extracted data 23 will typically require significant less storage capacity than the source data 22. The features extracted by the parser may be different depending on the implementation. According to one embodiment, the parser 17 is adapted to extract text strings 23 from the source data 22.

The normalizer 18 is arranged to receive the extracted features 23 from the parser 17, and convert them into a format that more easily can be compared on a binary level.

The remover 19 is arranged to receive binary comparable features 24, and remove common features which are not significant or representative, and store a reduced set of binary comparable features 26 in the database.

The signature definition module 25 is arranged to analyze the binary comparable features 26, and define genetic signatures in a way further described below.

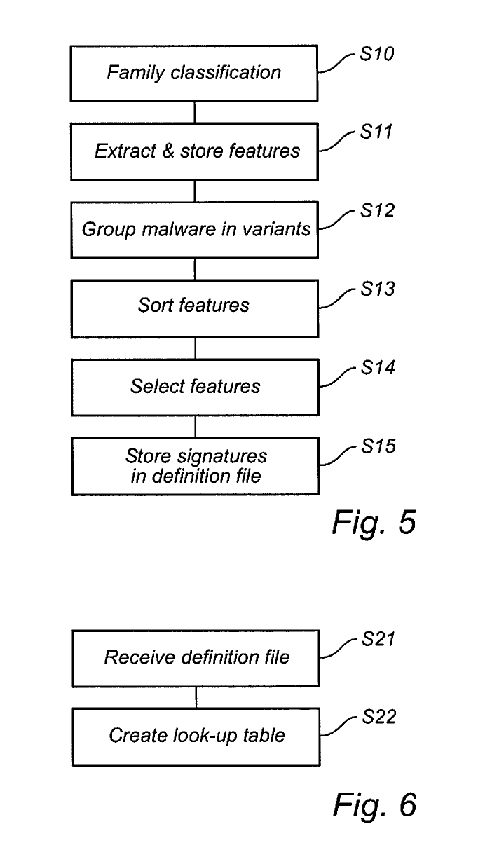

FIG. 3 shows the client part 3 of the system, comprising an I/O unit 30, connected to the network connection 4 as well as to any suitable user interface 31, such as keyboard, mouse, etc. The client 3 further comprises a memory 32 storing software code 33, and a processor 34, arranged to execute the software 33. When executed, the software 33 creates several processes running on the client 3, including a data scanner 35 and a genetic signature search engine 36. The scanner 35 may include a decoder 16, a parser 17 and a normalizer 18 as described in relation to the server 2.

The data scanner 35 is arranged to scan a collection of data 37, for example a data file received by the I/O-unit 30, at least temporarily stored in the memory 32. The decoder 16, parser 17 and normalizer 18 of the scanner 35 are arranged to extract binary comparable features 40 from the data collection 37. The genetic signature search engine 36 is arranged to determine if a scanned data collection 37 matches a genetic signature contained in a signature definition file 38 stored in memory, by accessing a look-up table 39 and comparing the extracted features 40.

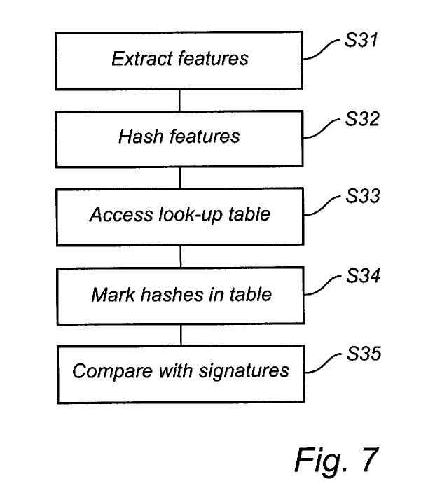

The procedure performed by the various functional blocks in FIG. 1-3 is also outlined in the flow charts in FIGS. 4-7.

FIG. 4 shows how binary comparable features are extracted from a specific collection of data, such as a malware file. The malware file 21 is decoded by decoder 16 (step S1) and the resulting source data 22 is parsed by the parser 17 (step S2), to extract identifiable features 23 which are normalized by the normalizer 18 (step S3) to make them comparable on a binary level.

The parsing procedure may utilize headers included in the data pointing to strings such as function names, or pointing to function implementations, which may be useful as features. Further parsing can be performed by reviewing the source data 22 character by character, in order to find groups of characters fulfilling predetermined requirements. These requirements may depend on the implementation, but in the case where the extracted features are text strings, the requirements intend to identify individual words or expressions. For example, it may be required that a useful text string comprises only letters, although it is probably more reasonable to require that it comprises mainly letters. The parsing can further be based on experience, which can be implemented in an AI system.

A minimum length of a useful text string may be predefined, in which case the parsing procedure is simplified. For example, if the predetermined minimum length is 12 characters, only every 12:th character in the byte sequence needs to be considered. Only if this character is considered to potentially belong to a useful text string, then the surroundings of this character will be analyzed further.

The extracted features are then normalized by the normalizer 18, in order to make them comparable on a binary level. For example, the normalizer 18 may be adapted to distinguish different types of string formats (e.g. Unicode, Pascal) and convert the strings to one common string format. Further, the normalizer 18 may perform minor homogenizations of the strings, such as convert all letters to either upper or lower case.

The resulting binary comparable features 24 are processed by the remover 19 in step S4, to exclude features which are unlikely to contribute to successful malware detection.

The remover 19 can be adapted to ignore (remove) those features that are deemed irrelevant, or unsuitable to base further genetic analysis on. Such removal may be based e.g. on prior knowledge that certain features, such as specific text strings, occur in a large portion of any software, making them superfluous and less useful as identifiers of specific malware.

The removal of features may be performed by accessing a list of features identified as superfluous. Such a list may be generated by performing steps S1-S3 for a set of standard software applications. The list may also be manually updated by a user, e.g. during manual assessment of features. In step S5, the remaining features 26 are stored in the database 12.

FIG. 5 illustrates how the stored binary comparable features 26 can be used to determine a genetic signature for a set of malware, referred to as a “variant”. This process is performed by the genetic signature module 25.

If considered advantageous, the malware may first (step S10) be classified in various families based on their general function, but this is not a requirement of the method. In step S11, the procedure in FIG. 4 is completed for all available malware, and all binary comparable features 26 from each malware are stored in the database.

Based on the features stored in the database, the malware is then divided into variants (step S12). The procedure to group malware into variants may be entirely automatic, and based on the features for each malware. For example, an “overlap” measure may be defined, which indicates to what extent two sets of features, belonging to different malware, overlap. In addition, it may be relevant to determine the relevance of the overlap, by comparing the size of the two overlapping sets of features. For example, a given overlap may be more relevant (e.g. 50%) for the smaller one of the sets, while it is less relevant (e.g. 10%) for the larger one of the sets. If the overlap is sufficiently large and sufficiently relevant, the two malwares are considered to form part of the same variant.

In step S13, the features of each variant are sorted in order of occurrence. The sorting order may also be influenced by the “specificity” of a feature, i.e. if it has high occurrence in one variant and at the same time a low occurrence in other variants. Then, the features having the highest (specific) occurrence in the variant are selected (step S14). The occurrence threshold used may vary depending on implementation and variant diversity, but many times a threshold of 100% may be useful. When the specificity is also considered, the threshold definition becomes more complex, as it combines occurrence in the present variant with occurrence in other variants. For example, the threshold could be occurrence in current variant greater than 80% and occurrence in other variants less than 20%.

Step S14 may be entirely automatic, and is preferably based on previous experience, for example applied in a suitable AI system. However, step S14 may also be partially manual, where a user is allowed to influence the selection of suitable features. Such a manual operation may further enhance the efficiency of the resulting genetic signatures, but is by no means necessary for the implementation of the invention.

In step S15, associations to the selected features of a variant are included in a genetic signature of this variant, and the signatures of all variants are stored in a definition file 38, which can be communicated to the client part 3. For each signature, the definition file can store representations of a number of features, a name of the variant associated with the signature, and a family identifier identifying which family the variant belongs to. In the following description, the representations are assumed to be hashes. The data may be stored according to the following format:

hash_entry

hash

signature

name
family identifier

hash_occurrence

signature index
hash_entry index

where hash_entry, signature, and hash_occurrence are arrays, containing all data and indexes to define the signatures. In order to ensure a predefined length of the type, the “name” entry is preferably a pointer to a data block storing the actual name. Of course, the details of the format may be optimized in many ways, e.g. by using more arrays to further normalize the information.

An initialization procedure performed in the client part 3 will be described with reference to FIG. 6.

In step S21, a signature definition file 38 is received from the server part 2, and stored in memory. Then, in step S22, a look-up table 39 is created based on the hashes in the definition file (in the present example, the hash_entry array), and stored in memory 32. The data in the array is partitioned in groups, for example 256 or 65536 groups, and the hashes are sorted according to their first byte or first and second bytes. Such a partitioning may facilitate and expedite the look-up procedure. As an example, hash_entry may be divided into 65536 groups (sub-tables), allowing for use of the first two bytes of a hash as index.

The scanning procedure performed in the client part 3 will be described with reference to FIG. 7.

First, in step S31, a collection of data (e.g. a data file or data stream) is processed according to steps S1-S3 in FIG. 4, to extract a set of binary comparable features. Then, in step S32, representation of these features are calculated, in the illustrated example the representations are hashes.

In the following step S33, the look-up table 39 is accessed to look up the calculated hashes. If the look-up table is partitioned as described above, the first byte, or first two bytes, of each hash can be used to locate the relevant sub-table. A binary search algorithm, such as “divide and conquer” can then be used to determine if the sub-table includes the hash. The resolution (number of hashes per sub-table) of the look-up table will determine the speed of the look-up.

Each time a hash is located in the look-up table, this table entry is marked in a suitable manner (step S34), for example in a separate table, and in step S35 the marked entries are compared with the signatures defined in the definition file, in the above example defined by the entries in the hash_occurrence array.

If a data collection is found to include all features of a specific genetic signature, the data collection is determined to belong to the variant of malware associated with this signature. Appropriate counter measures may be launched, and may be highly specific due to the very specific identification of malware.

It is important to note that the above procedure allows comparing the features extracted from a collection of data with all signatures in the definition file 38 during one single scan procedure. The method is thus extremely efficient.

The person skilled in the art realizes that the present invention by no means is limited to the preferred embodiments described above. On the contrary, many modifications and variations are possible within the scope of the appended claims.

What is claimed is:

1. A method for automatically generating a genetic signature for a set of malware, comprising:
for each malware in the set, parsing said malware to identify a set of binary comparable features present in said malware, which features are comparable on a binary level,
storing all binary comparable features occurring in said set of malware,
determining a subset of binary comparable features, said subset comprising binary comparable features occurring in at least a predetermined portion of all malware in the set, and
including representations of the binary comparable features in said subset in said genetic signature.

2. The method according to claim 1, said subset comprising binary comparable features occurring in at least a first predetermined portion of malware in said set, and no more than a second predetermined portion of malware in other sets.

3. The method according to claim 1, wherein each representation has a predetermined length.

4. The method according to claim 3, wherein each representation is a hash.

5. The method according to claim 1, further comprising normalizing said extracted features.

6. The method according to claim 1, wherein the binary comparable features include text strings.

7. The method according to claim 1, wherein the binary comparable features represent functional content.

8. The method according to claim 1, wherein said predetermined portion is 100%.

9. The method according to claim 1, further comprising the step of removing, from said subset, binary comparable features with high occurrence in all software.

10. The method according to claim 1, wherein said malware set comprises malware having similar malicious functionality.

11. A method for determining whether a data collection belongs to a specific set of malware, comprising:
storing a set of representations of binary comparable features associated with a set of genetic signatures,
creating a look-up table where each entry is associated with one of said representations,
parsing said data collection to identify a set of binary comparable features present in said data collection,
marking entries in said look-up table associated with identified binary comparable features, and
determining that said data collection belongs to a specific set of malware if every entry associated with a binary comparable feature of a genetic signature representing said specific malware set is marked.

12. The method according to claim 11, wherein each representation has a predetermined length.

13. The method according to claim 12, wherein each representation is a hash of a binary comparable feature, the method further comprising hashing said identified binary comparable features.

14. The method according to claim 13, wherein the table comprises a set of 256 tables, wherein each table stores hashes having a specific first byte.

15. The method according to claim 13, wherein the table comprises a set of 65536 tables, wherein each table stores hashes beginning with a specific combination of two bytes.

16. The method according to claim 11, wherein the determining step is repeated for a plurality of sets of malware.

17. The method according to claim 11, wherein said genetic signatures are generated by:
for each malware in the set, parsing said malware to identify a set of binary comparable features present in said malware, which features are comparable on a binary level,
storing all binary comparable features occurring in said set of malware,
determining a subset of binary comparable features, said subset comprising binary comparable features occurring in at least a predetermined portion of all malware in the set, and
including representations of the binary comparable features in said subset in said genetic signature.

18. A computer program product, including computer code portions adapted to perform a method according to claim 1 when run on a computer.

19. A computer readable medium, comprising a computer program product according to claim 18.

20. A computer program product, including computer code portions adapted to perform a method according to claim 11 when run on a computer.

21. A computer readable medium, comprising a computer program product according to claim 20.
